(19) United States
(12) Patent Application Publication
(10) Pub. No.: US 2006/0255162 A1
(43) Pub. Date: Nov. 16, 2006

(54) DATA CARD AND DATA ENCODED STRIP

(76) Inventor: Nick Nicholas, Fort Collins, CO (US)

Correspondence Address: ANCEL W. LEWIS, JR., 425 WEST MULBERRY, SUITE 101, FORT COLLINS, CO, 80521, US

(21) Appl. No.: 11/308,702

(22) Filed: Apr. 24, 2006

Related U.S. Application Data
(60) Provisional application No. 60/594,642, filed on Apr. 26, 2005.

(51) Int. Cl. G06K 19/06

(52) U.S. Cl. 235/493

(57) ABSTRACT

A folding data card has two parts connected at a common edge such that the two parts can rotate relative to each other. A data encoded strip on one of the parts is spaced inwardly from the common edge a standard distance. When the card is folded with the strip facing out, the strip can be read by a standard card reader. When the card is folded with the strip facing in, the strip is protected. A removable third part is provided for retail display.

This application claims the benefit under 35 U.S.C. § 119(e) of the U.S. provisional patent application No. 60/594,642 filed Apr. 26, 2005.

### TECHNICAL FIELD

The present invention relates to data cards and more particularly to a folding data card with a data encoded strip.

### BACKGROUND ART

Data cards have many uses, such as credit cards, debit cards, phone cards, gift cards and card keys. Data on these data cards is generally encoded on a data encoded strip, such as a magnetic stripe.

The International Organization for Standardization, known as ISO, provides standards that define the characteristics of data cards, including the size and thickness of the cards, and the positioning and format of magnetic stripes. Standardization of the data card size, of the data card thickness and of the distance from a reference edge to the magnetic stripe all facilitate machine reading and writing of the magnetic stripe.

The ID-1 format that is defined in ISO 7810 is commonly used for banking cards and has a size of 85.60×53.98 mm, or 3.375×2.125 inches, and a thickness of 0.76 mm or 0.030 inches. The magnetic stripe extends across one face of the card, parallel to the reference edge. The magnetic stripe is spaced inwardly a standard distance of 0.218 inches from the reference edge of the card, and is typically 0.375 to 0.500 inches wide.

Magnetic stripes have two varieties, low coercivity and high coercivity. Low coercivity magnetic stripes are more easily written than high coercivity magnetic stripes. Low coercivity magnetic stripes are generally used for gift cards, phone cards and card keys. High coercivity magnetic stripes are generally used for credit cards. The magnetic stripe can be damaged. The magnetic stripe can also be accidentally read or written. It is desirable to provide a data card that provides protection for the magnetic stripe.

### DISCLOSURE OF THE INVENTION

A data card includes generally rectangular first, second and third portions. The first and second portions are generally rectangular with rounded corners, each having a first edge and a second edge spaced from the first edge. The first portion is the size of a standard card and has a first thickness. The second portion has a second thickness, with the combined first and second thicknesses equaling the thickness of a standard card. The first and second portions are pivotally connected along the first edges so that the second portion can be folded against either face of the first portion. A data encoded strip on the second portion is spaced from the first edge by the standard distance and spaced from the second edge by a distance greater than the standard distance. The third portion is removably connected to the second edge of the first portion and includes a display aperture for retail display of the card. Another card has the data coded strip on the first portion instead of the second portion.

When the second portion is folded against the first portion with the data encoded strip facing outwardly, the data encoded strip can be read by a card reader. When the second portion is folded against the first portion with the data encoded strip facing inwardly, the data encoded strip is protected.

### BRIEF DESCRIPTION OF THE DRAWINGS

Details of this invention are described in connection with the accompanying drawings that bear similar reference numerals in which:

FIG. 1 is a front elevation view of a data card embodying features of the present invention.

FIG. 2 is a rear elevation view of the card of FIG. 1.

FIG. 3 is an enlarged, partial sectional view taken along line 3-3 of FIG. 1.

FIG. 4 is a side elevation of the card of FIG. 1 with the second portion folded forwardly and the third portion removed.

FIG. 5 is a front elevation view of the card of FIG. 1 with the second portion folded forwardly and the third portion removed.

FIG. 6 is a rear elevation view of the card of FIG. 1 with the second portion folded rearwardly and the third portion removed.

FIG. 7 is a rear elevation view of another card embodying features of the present invention.

### DETAILED DESCRIPTION OF THE INVENTION

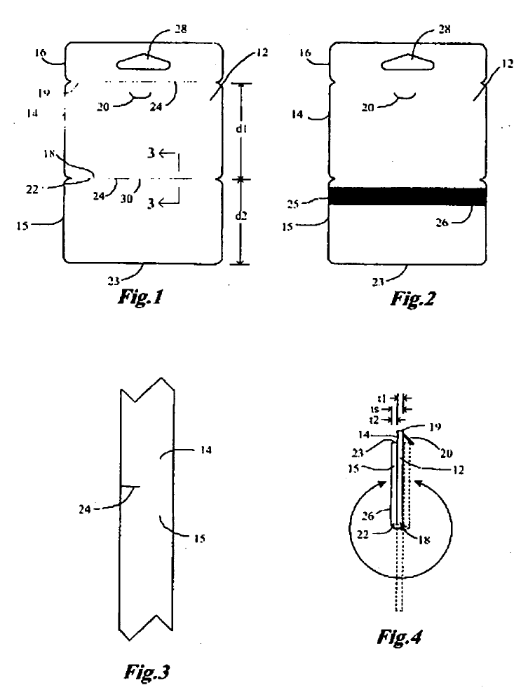

Referring now to FIGS. 1 to 6, a data card 12 embodying features of the present invention is generally made of plastic, or a laminated plastic or paper like material, and the card 12 can be made by die cutting methods. The card 12 includes a first portion 14, a second portion 15 and a third portion 16. The first portion 14 is flat and generally rectangular with rounded corners. The first portion 14 is a standard card size, such as the ID-1 format. The first portion 14 includes a first edge 18 and a second edge 19 spaced a first distance d1 from the first edge 18. The first portion 14 has a first thickness t1, that is less than the standard thickness ts of a data card.

Describing the specific embodiments herein chosen for illustrating the invention, certain terminology is used which will be recognized as being employed for convenience and having no limiting significance. For example, the terms “front” and “rear” refer to the illustrated embodiment as referenced to the first portion 14. Further, all of the terminology above-defined includes derivatives of the word specifically mentioned and words of similar import.

The first portion 14 has tab 20 near the second edge 19. The tab 20 shown is a semi-circular cut through the first portion 14, with the convex side towards the first edge 18. The tab 20 is spaced substantially a second distance d2 from the first edge, with the second distance d2 being less than the first distance d1.

The second portion 15 is flat and generally rectangular with rounded corners. The second portion 15 includes a first edge 22 and a second edge 23 spaced the second distance d2 from the first edge 22. The second portion 15 has a second thickness t2. The first and second thicknesses t1 and t2 combined equal the standard thickness ts. The first and second thicknesses t1 and t2 shown are equal, but the first and second thicknesses t1 and t2 can differ. The first and second portions 14 and 15 are pivotally connected along the first edges 18 and 22, such that the second portion 15 can be folded against the first portion on either side.

As best seen in FIGS. 1 and 3, in the card 12 shown, two spaced kiss cuts 24 are made between the first edges 18 and 22 of the first and second portions 14 and 15, leaving three uncut, spaced hinge portions 30 connecting the first edges 18 and 22 of the first and second portions 14 and 15. Kiss cuts generally are die cuts that extend through only a portion of the thickness of the material, and the kiss cuts 24 shown extend into the card 12 about one third of the thickness of the card 12. When the card 12 is folded, the kiss cuts 24 break apart while the hinge portions 30 flex and remain intact. Other methods and structure can be used to pivotally connect the first edges 18 and 22 of the first and second portions 14 and 15. The tab 20 on the first portion 14 holds the second edge 23 of the second portion 15, to secure the second portion 15 against the first portion 14.

A data encoded strip 25, shown as a magnetic stripe 26, on the second portion 15, extends parallel to the first edge 22 and spaced from the first edge 22 by the standard distance ds. The distance from the magnetic stripe 26 to the second edge 23 of the second portion 15 is greater than standard distance ds. The magnetic strip 26 can only be read by a standard magnetic card reader when the second portion 15 is folded against the first portion 14, with the magnetic stripe 26 facing outwardly. When the second portion 15 is folded against the first portion 14, with the magnetic stripe 26 facing inwardly, the magnetic strip 25 is protected from accidental reading and physical damage.

The third portion 16 shown is flat and generally rectangular with rounded corners. The third portion 16 can be other shapes. The third portion 16 is removably connected to the second edge 19 of the first portion 14. In the card 12 shown, a kiss cut 24 extends along the second edge 19 of the first portion 14. The kiss cut 24 extends into the card 12 about one third of the thickness of the card 12. When the card 12 is folded, the kiss cut 24 breaks apart, separating the third portion 16 from the first portion 14. The third portion 16 is provided for display purposes only. A display aperture 28 extends through the third portion 16, for hanging the card 12 on a retail display.

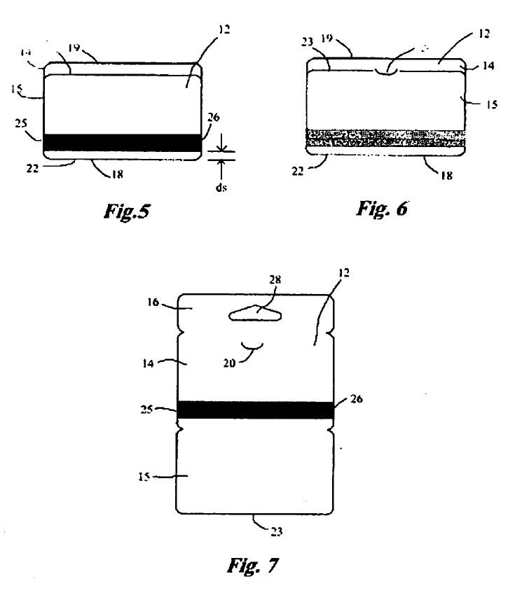

FIG. 5 shows the card 12 with the magnetic stripe 26 on the first portion 14, instead of the second portion 15. The magnetic stripe 26 extends parallel to the first edge 18 and spaced from the first edge 18 by the standard distance ds. The distance from the magnetic stripe 26 to the second edge 19 of the first portion 14 is greater than standard distance ds. The magnetic strip 26 can only be read by a standard magnetic card reader when the second portion 15 is folded against the first portion 14, with the magnetic stripe 26 facing outwardly. When the second portion 15 is folded against the first portion 14, with the magnetic stripe 26 facing inwardly, the magnetic strip 25 is protected from accidental reading and physical damage.

Although the present invention has been described with a certain degree of particularity, it is understood that the present disclosure has been made by way of example and that changes in details of structure may be made without departing from the spirit thereof.

What is claimed is:

1. A data card for use with a reader for reading a standard data card with a standard size, a standard thickness, a reference edge, and a data encoded strip spaced a standard distance from said reference edge, comprising:
a generally rectangular first portion with a selected first thickness, said first portion having a first edge and a second edge spaced from said first edge,
a generally rectangular second portion having a selected second thickness with said first and second thicknesses combined equaling said standard thickness, said second portion having a first edge and a second edge spaced from said first edge, said first edge of said second portion being pivotally connected to said first edge of said first portion, and
a data encoded strip on one of said first and second portions, said data encoded strip extending parallel to and spaced said standard distance from the respective said first edge, and spaced a distance greater than said standard distance from the respective said second edge,
whereby when said second portion is folded against said first portion with said data encoded strip facing outwardly, said data encoded strip is readable by said reader, and when said second portion is folded against said first portion with said data encoded strip facing inwardly, said data encoded strip is protected.

2. The card as set forth in claim 1 wherein said data encoded strip is on said second portion.

3. The card as set forth in claim 1 wherein said data encoded strip is on said first portion.

4. The card as set forth in claim 1 wherein said first and second thicknesses are equal.

5. The card as set forth in claim 1 wherein said first portion is said standard size with said first and second edges of said first portion being spaced a first distance.

6. The card as set forth in claim 5 wherein said first and second edges of said second portion are spaced a second distance that is less than said first distance.

7. The card as set forth in claim 6 wherein said first portion includes a tab spaced substantially said second distance from said first edge of said first portion, for securing said second portion when said second portion is folded to against said first portion.

8. The card as set forth in claim 1 wherein said data encoded strip is a magnetic stripe.

9. The card as set forth in claim 8 wherein said magnetic stripe is a low coercivity magnetic stripe.

10. The card as set forth in claim 8 wherein said magnetic stripe is a high coercivity magnetic stripe.

11. The card as set forth in claim 1 including a third portion removably connected to said second edge of said first portion.

12. The card as set forth in claim 9 wherein said third portion includes a display aperture for hanging said third portion on a retail display.

13. The card as set forth in claim 1 wherein said first edge of said second portion is pivotally connected to said first edge of said first portion by a plurality of spaced hinge portions.

14. The card as set forth in claim 13 wherein said hinge portions are separated by kiss cuts.

15. A data card for use with a reader for reading a standard data card with a standard size, a standard thickness, a reference edge, and a data encoded strip spaced a standard distance from said reference edge, comprising:
a generally rectangular first portion with a selected first thickness, said first portion having a first edge and a second edge spaced a first distance from said first edge, said first portion having a tab spaced a second distance from said first edge, said second distance being less than said first distance,
a generally rectangular second portion having a selected second thickness equal to said first thickness, with said first and second thicknesses combined equaling said standard thickness, said second portion having a first edge and a second edge spaced said second distance from said first edge, said first edge of said second portion being pivotally connected to said first edge of said first portion,
a magnetic stripe on said second portion, said magnetic stripe extending parallel to and spaced said standard distance from said first edge of said second portion, and spaced a distance greater than said standard distance from said second edge of said second portion, and
a third portion removably connected to said second edge of said first portion, said third portion including a display aperture for hanging said third portion on a retail display,
whereby when said second portion is folded against said first portion with said data encoded strip facing outwardly, said data encoded strip is readable by said reader, and when said second portion is folded against said first portion with said data encoded strip facing inwardly, said data encoded strip is protected.

16. A data card for use with a reader for reading a standard data card with a standard size, a standard thickness, a reference edge, a second edge spaced from said reference edge by a standard depth, and a data encoded strip spaced a standard distance from said reference edge, comprising:
a generally rectangular first portion with a selected first thickness, said first portion having a first edge and a second edge spaced a first distance from said first edge, said first portion having a tab spaced a second distance from said first edge, said second distance being less than said first distance,
a generally rectangular second portion having a selected second thickness equal to said first thickness, with said first and second thicknesses combined equaling said standard thickness, said second portion having a first edge and a second edge spaced said second distance from said first edge, said first edge of said second portion being pivotally connected to said first edge of said first portion,
a magnetic stripe on said first portion, said magnetic stripe extending parallel to and spaced said standard distance from said first edge of said first portion, and spaced a distance greater than said standard distance from said second edge of said first portion, and
a third portion removably connected to said second edge of said first portion, said third portion including a display aperture for hanging said third portion on a retail display,
whereby when said second portion is folded against said first portion with said data encoded strip facing outwardly, said data encoded strip is readable by said reader, and when said second portion is folded against said first portion with said data encoded strip facing inwardly, said data encoded strip is protected.
